(19) United States
(12) Patent Application Publication
(10) Pub. No.: US 2003/0081273 A1
(43) Pub. Date: May 1, 2003

(54) Mechanism for compensating linear velocity differential, conveyance mechanism and image forming apparatus

(75) Inventors: Tsutomu Masuo, Kanagawa (JP); Hiroshi Inoue, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/253,915

(22) Filed: Sep. 25, 2002

(30) Foreign Application Priority Data
Sep. 28, 2001 (JP) 2001-302647

(51) Int. Cl. H04N 1/04

(52) U.S. Cl. 358/498

(57) ABSTRACT

A mechanism for compensating linear velocity differential that has a simple structure and with which it is possible to efficiently compensate difference in linear velocity between conveyance roller pairs. In a case in which a sheet is conveyed by two pairs of conveyance rollers, when the speed (linear velocity) at which the sheet is conveyed by one pair of conveyance rollers disposed downstream in the conveyance direction is higher than the speed at which the sheet is conveyed by the other pair of conveyance rollers disposed upstream, the linear velocity differential causes a tension in the sheet that is applied to the upstream pair of conveyance rollers. Due to this tension, a drive roller is rotated at a higher rotational speed than that of a drive gear, so that engaging prongs of the drive roller are respectively removed from engaging protrusions of the drive gear. Namely, the drive roller rotates and follows the downstream conveyance speed, whereby overload of the sheet is prevented.

### BACKGROUND OF THE INVENTION

1. Field of the Invention

The present invention relates to a mechanism for compensating linear velocity differential in a conveyance system, in which a sheet-shaped product is nipped and conveyed by a pair of conveyance rollers, to a conveyance mechanism incorporating therein the mechanism, and to an image forming apparatus to which the mechanism is applied.

2. Description of the Related Art

Conventionally, a conveyance system has been employed in which a sheet-shaped product (referred to below as a sheet) is nipped and conveyed by a pair of conveyance rollers. In this type of conveyance system, the sheet is basically conveyed at a uniform speed. However, there are cases in which conveyance speed varies depending upon the specifications of sheet processing. In such a case, there is the potential for the sheet to be overloaded (pulled) when the speed (linear velocity) at which the sheet nipped between the pair of conveyance rollers is conveyed is higher downstream from the pair of conveyance rollers than at the pair of conveyance rollers (when there is linear velocity differential). Therefore, to prevent overloading of the sheet, a one-way clutch is disposed between a drive roller, which forms one of the pair of conveyance rollers, and a drive gear that transmits a driving force to the drive roller.

More specifically, due to the presence of the one-way clutch between the drive roller and the drive gear, the drive roller can be rotated so as to respond to the speed (linear velocity) at which the sheet is conveyed downstream. As a result, compensating for the pulling force resulting from the linear velocity differential has prevented excessive pulling of the sheet.

However, in conventional structures, there is a disadvantage in that disposing a one-way clutch between a drive roller and a drive gear, or employing a custom-built drive gear with a one-way clutch incorporated therein, has brought about an increase in costs.

There is another disadvantage in that one-way clutches easily break due to friction.

### SUMMARY OF THE INVENTION

In light of the above-mentioned facts, a primary object of the present invention is to provide a mechanism for compensating linear velocity differential that is simple in structure, free of the aforementioned conventional drawbacks, and efficiently compensates differences in linear velocity between pairs of conveyance rollers. It is also an object of the invention to provide an image forming apparatus that incorporates therein the mechanism for compensating linear velocity differential.

To achieve this object, according to one aspect of the present invention, there is provided a mechanism for compensating linear velocity differential, the mechanism being incorporated between a conveyance element that conveys a sheet and a transmitting element that is operatively connected to a drive source and comprising: an engaging portion that is operatively connected to the conveyance element; and an abutment portion that is operatively connected to the transmitting element and is detachable from and attachable to the engaging portion, wherein a driving force from the drive source is transmitted to the conveyance element by the abutment portion being pressed against the engaging portion.

In accordance with another aspect of the present invention, there is provided a conveyance mechanism for conveying a sheet, the conveyance mechanism comprising: (A) a first conveyance element; (B) a second conveyance element that is disposed upstream of the first conveyance element relative to the conveyance direction, is able to grip the sheet simultaneously with the first conveyance element, and is rotatingly driven at a lower linear velocity than the first conveyance element; and (C) a mechanism for compensating linear velocity differential including a transmitting element that is operatively connected to a drive source, the mechanism being incorporated between the transmitting element and the second conveyance element and including; (i) an engaging portion operatively connected to the second conveyance element; and (ii) a predetermined number of abutment portions operatively connected to the transmitting element and detachable from and attachable to the engaging portion, wherein a drive force from the drive source is transmitted to the second conveyance element by the abutment portions being pressed against the engaging portion.

Moreover, in accordance with a further aspect of the present invention, there is provided an image forming apparatus comprising: (a) an image forming unit for forming an image on a recording material; (b) a first conveyance roller pair for grippingly conveying the recording material, the first conveyance roller pair being disposed downstream of an image forming position relative to the conveyance direction; (c) a second conveyance roller pair is disposed upstream in the conveyance direction from the image forming position, is able to grip the sheet simultaneously with the first conveyance roller pair, and is rotatingly driven at a lower linear velocity than the first conveyance roller pair; and (d) a mechanism for compensating linear velocity differential which includes a transmitting element that is operatively connected to a drive source, the mechanism being incorporated between the transmitting element and one roller of the second conveyance roller pair.

In accordance with still further aspect of the present invention, there is an image forming apparatus comprising: (a) a liquid-processing unit for liquid-processing a recording material, on which an image has been formed, to form a predetermined image on the recording material; (b) a primary drive roller pair for grippingly conveying the recording material, the primary drive roller pair being disposed downstream of a liquid-processing position relative to the conveyance direction; (c) a secondary drive roller pair disposed upstream of the liquid-processing position relative to the conveyance direction, said secondary drive roller being able to grip the recording material simultaneously with the primary drive roller pair, and rotatingly driven at a lower linear velocity than the primary drive roller pair; and (d) a mechanism for compensating linear velocity differential, which mechanism includes a transmitting element that is operatively connected to a drive source, the mechanism being incorporated between the transmitting element and one roller of the secondary drive roller pair.

The foregoing and other objects, features and advantages of the present invention will be apparent from the following description of preferred embodiments of the invention, as illustrated in the accompanying drawings.

### BRIEF DESCRIPTION OF THE DRAWINGS

FIG. 1 is a schematic view showing a conveyance mechanism according to a first embodiment of the present invention.

FIG. 2 is an enlarged perspective view of the mechanism for compensating linear velocity differential according to the first embodiment.

FIG. 3 is a side view of a main portion of the mechanism for compensating linear velocity differential according to the first embodiment.

FIG. 4 is a schematic general view of an image forming apparatus to which a mechanism for compensating linear velocity differential according to a second embodiment of the invention is applied.

FIG. 5 is an explanatory view showing the image forming apparatus according to the second embodiment in operation.

FIG. 6 is an explanatory view showing a main portion of an exposure section of the image forming apparatus according to the second embodiment.

FIG. 7 is an explanatory view showing a main portion of a water-coating section of an image forming apparatus according to a third embodiment of the invention.

FIG. 8 is a perspective view showing another example of the mechanism for compensating linear velocity differential according to the first embodiment of the present invention.

FIG. 9 is an exploded perspective view of a gear for compensating linear velocity differential according to the first embodiment of the present invention.

FIG. 10 is a side view showing another example of the conveyance mechanism according to the first embodiment of the present invention.

FIG. 11 is an enlarged perspective view showing a modified example of the mechanism according to the first embodiment.

### DESCRIPTION OF THE PREFERRED EMBODIMENTS

First Embodiment

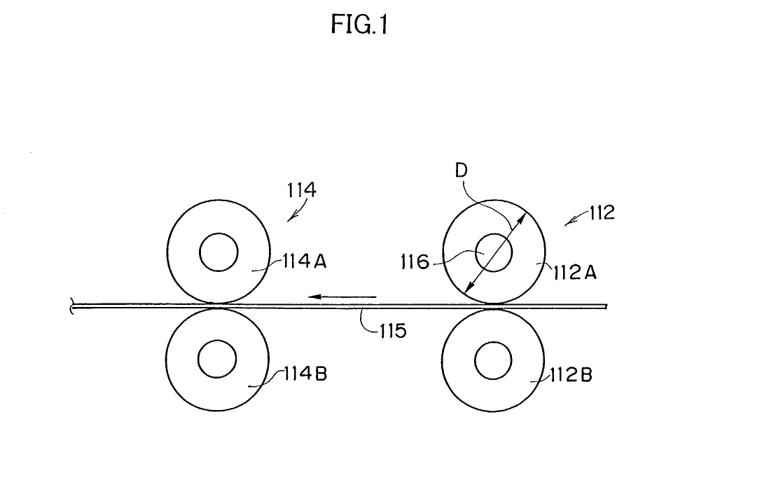

Referring now to FIGS. 1 to 3, a conveyance mechanism that includes a mechanism for compensating linear velocity differential in a conveyance system according to a first embodiment of the present invention will be described below.

As shown in FIG. 1, the conveyance system includes a pair of conveyance rollers 112, which are disposed upstream in a conveyance direction, and a pair of conveyance rollers 114, which are disposed downstream in the conveyance direction. The conveyance roller pairs 112 and 114 concurrently hold a sheet-shaped object 115 (referred to as a sheet below) while it is conveyed.

The conveyance roller pairs 112 and 114 respectively include upper drive rollers 112A and 114A and lower driven rollers 112B and 114B, all of which are made of rubber. Each of the driven rollers 112B and 114B nips the sheet 115 with the corresponding drive rollers 112A and 114A and is rotatingly driven by the corresponding drive rollers 112A and 114A.

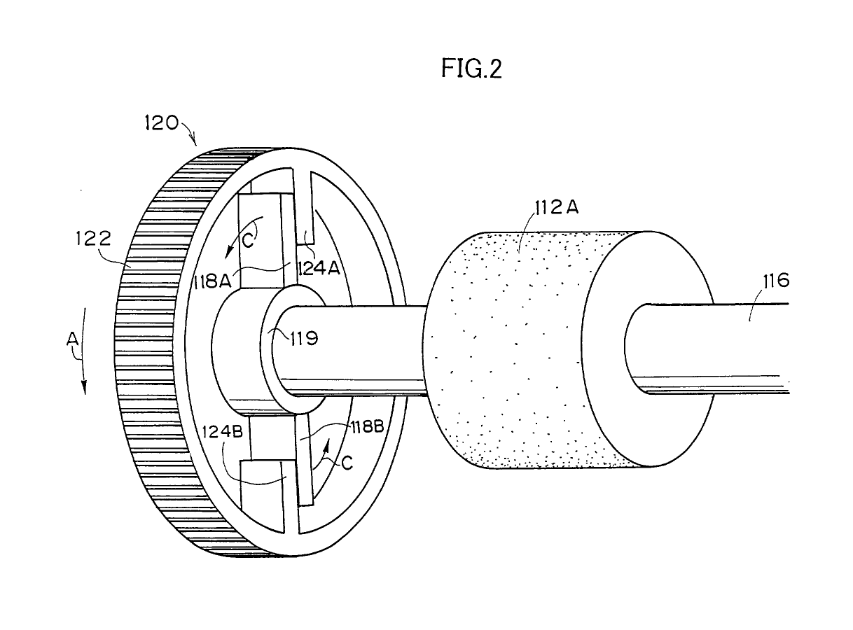

As shown in FIG. 2, a drive shaft 116, on which the drive roller 112A is mounted, includes a shaft end at which an engaging member 119 is disposed. The engaging member 119 is disposed with a pair of engaging prongs 118A and 118B that extend radially outward from the engaging member 119 and are formed at diametrically opposite positions with respect to an axis of the drive shaft 116.

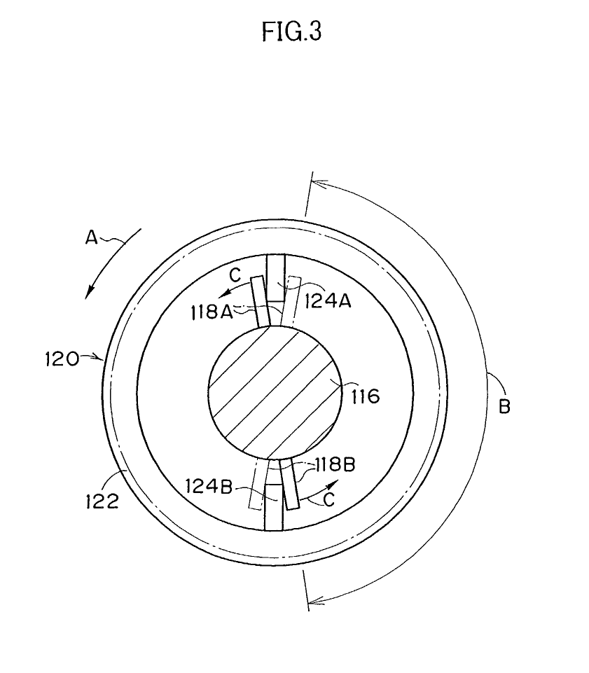

A driving force from a drive source (not shown) is transmitted to the drive shaft 116 through a drive gear 120. The drive gear 120 includes an outer peripheral surface disposed with teeth 122, which mesh with another gear that transmits the driving force from the drive source. The drive gear 120 also includes an internal surface from which a pair of engaging protrusions 124A and 124B project radially inward. As shown in FIG. 3, the engaging protrusions 124A and 124B are formed at diametrically opposite positions with respect to a rotational axis of the drive gear 120 (i.e., the axis of the drive shaft 116).

The diameter of the drive roller 112A is set and the conveyance speed is controlled so as to satisfy the following relation:

πD/{2(V1−V2)}>Lmax/V2 (1)

where D (mm) is the diameter of the drive roller 112A, V1 (mm/s) is the speed (i.e., linear velocity) at which the sheet is conveyed by the conveyance roller pair 114, V2 (mm/s) is the speed (i.e., linear velocity) at which the sheet is conveyed by the conveyance roller pair 112, and L max (mm) is the maximum length of the sheet in a sheet conveyance direction.

Further, the drive roller 112A is structured to satisfy the following relation:

πD/n<G (2)

wherein G (mm) is the minimum interval of sheets (i.e., a distance in the conveyance direction between a trailing end of a preceding sheet and a leading end of a subsequent sheet).

Operation of the conveyance mechanism (or the mechanism for compensating linear velocity differential) thus structured will now be described in detail.

Firstly, a typical mode will be described in which the conveyance roller pairs 112 and 114 are rotated at the same rotational speed (i.e., a mode in which the conveyance roller pairs 112 and 114 convey the sheet 115 at the same linear speed). In this mode, the drive gear 120 is rotated in the direction of arrow A by a rotational force transmitted through the teeth 122 from the unillustrated drive source. The engaging protrusions 124A and 124B of the drive gear 120 abut and press the engaging prongs 118A and 118B of the engaging member 119 fixedly secured to the drive shaft 116 (see the solid line position in FIG. 3). As a result, the drive gear 120 and the drive shaft 116 rotate integrally.

The sheet 115 is nipped and conveyed at a predetermined speed by the drive roller 112A (the conveyance roller pair 112) mounted on the drive shaft 116 to which the rotational force is transmitted. The speed (i.e., linear velocity V2) at which the sheet 115 is conveyed by the drive roller 112A (the conveyance roller pair 112) and the speed (i.e., linear velocity V1) at which the sheet 115 is conveyed by the drive roller 114A (the conveyance roller pair 114) are set to be equal. In this case, because the linear velocity differential between the conveyance speeds of the conveyance roller pairs 112 and 114 is zero, the sheet 115 is regularly conveyed without being overly pulled.

When the speeds at which the conveyance roller pairs 112 and 114 respectively convey the sheet 115 are set to be different, and more specifically, when the speed (i.e., the linear velocity V2) at which the sheet 115 is conveyed by the conveyance roller pair 112 (the drive roller 112A) is set to be lower than the speed (i.e., the linear velocity V1) at which the sheet 115 is conveyed by the conveyance roller pair 114 (the drive roller 114A), a pulling force is generated due to the linear velocity differential (V1-V2) and acts on the conveyance roller pair 112 through the sheet 115 being nipped by the conveyance roller pair 114.

Due to the action of this force, the rotational speed (i.e., the linear velocity) of the drive roller 112A is faster than the rotational speed (i.e., the linear velocity V2) of the drive gear 120. As a result, the engaging prongs 118A and 118B disposed on the shaft end of the drive shaft 116 move at a speed based on the linear velocity differential (V1-V2) in the direction of arrow C away from the engaging protrusions 124A and 124B within a range of rotation B of the drive gear 120 being rotated at the linear velocity V2. In other words, the engaging prongs 118A and 118B on the drive shaft 116 move (move idly) or rotate freely but on a basis of the linear velocity differential (V1-V2) without abutting or contacting the engaging protrusions 124A and 124B, such that the action of the force due to the linear velocity differential (V1-V2) may be compensated.

As described above, the engaging prongs 118A and 118B move away from the engaging protrusions 124A and 124B so as to compensate the linear velocity differential. However, if the drive source continuously keeps causing the drive roller 112A to rotate after the sheet 115 has passed the drive roller 112A, the engaging prongs 118A and 118B can return or move to an original position in which the engaging prongs 118A and 118B respectively abut the engaging protrusions 124A and 124B.

As described above, in the mechanism for compensating linear velocity differential according to the present embodiment, the pair of engaging prongs 118A and 118B are disposed on the shaft end of the drive shaft 116, and the pair of engaging protrusions 124A and 124B are disposed on the internal surface of the drive gear 120 such that the engaging protrusions 124A and 124B define a turning range in which the engaging prongs 118A and 118B are rotatable by 180 degrees. Thus, when a linear velocity differential is generated between the conveyance roller pairs 112 and 114 nipping the sheet 115, the engaging prongs 118A and 118B freely move or rotate such that the linear velocity differential (V1-V2) between the conveyance roller pairs 112 and 114 is effectively compensated.

In this way, linear velocity differential can be efficiently compensated by the simple structure. Thus, the cost of manufacturing such a mechanism for compensating linear velocity differential can be reduced as compared with a mechanism incorporating a one-way clutch or the like. Further, the structure is simply formed such that the engaging prongs 118A and 118B disposed on the shaft end of the drive shaft 116 may respectively abut the engaging protrusions 124A and 124B disposed on the internal surface of the drive gear 120. Therefore, the potential for breakage or damage to occur is even more reduced.

Incidentally, although description has been given in the present embodiment of an operation in which the sheets are conveyed in a predetermined single direction, a similar operation and effect can be obtained in a case where the sheets are conveyed in the opposite direction. Further, although the mechanism for compensating linear velocity differential is disposed only at the conveyance roller pair 112 in this embodiment, another mechanism for compensating linear velocity differential can also be disposed at the conveyance roller pair 114 in place of or in addition to the mechanism disposed at the conveyance roller pair 112.

Moreover, although a pair of engaging prongs and a pair of engaging protrusions are disposed in the present embodiment, a structure is also possible in which only one engaging prong and only one engaging protrusion are provided. In this instance, the range of rotation B can be widened up to nearly 360 degrees. Thus, the range of linear velocity differential that can be compensated is widened.

If control is carried out to satisfy the above-described equation (1), it is possible to ensure compensation of velocity differential (linear velocity differential), no matter what the size of the sheets 115.

This is because the maximum time of rotation, πD/{2(V1-V2) }, that the engaging prongs 118 rotate (or rotate idly) within the range of rotation B is set to be longer than the maximum transit time, L max/V2, during which the sheet passes through the conveyance roller pair 112, and therefore, the rotation (or idle running) of the engaging prongs 118, which rotation is generated due to velocity differential at the time of the passing of the respective sheets, can be included within the range of rotation B.

In other words, if velocity differential cannot be compensated for when the engaging prongs 118A and 118B overly rotate in the direction of arrow C and hit the engaging protrusions 124B and 124A (see the position indicated by double-dotted line in FIG. 3), there is the potential that excessive tension will act on the sheet 115 or that slippage of the sheet 115 will be generated at the conveyor roller pairs 112 and 114. However, in the present embodiment, such inconveniences can be surely eliminated.

Further, if the drive roller 112A is structured such that the above-described formula (2) is satisfied, it is possible to restore the engaging prongs 118A and 118B, which are detached from the engaging protrusions 124A and 124B, to an abutment state (hereinafter referred to as an initial state or position (see the solid line position in FIG. 3)) in which the engaging prongs 118A and 118B respectively abut the engaging protrusions 124A and 124B, before a subsequent sheet is nipped by the conveyance roller pair 112. When the subsequent sheet is nipped by the conveyance roller pair 114 before the engaging prongs 118A and 118B are returning to the initial state, the conveyance roller pair 112 is not driven until the engaging prongs 118A and 118B respectively abut the engaging protrusions 124A and 124B. Thus, there is the potential for the sheet to slip or be creased. However, in the present embodiment, such drawbacks can be eliminated.

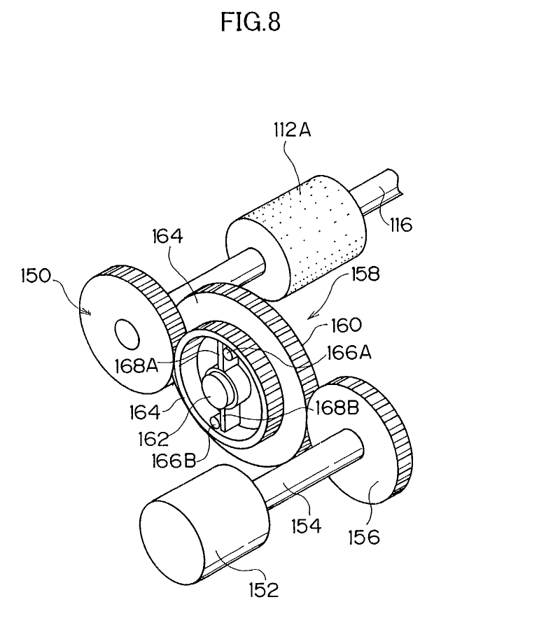

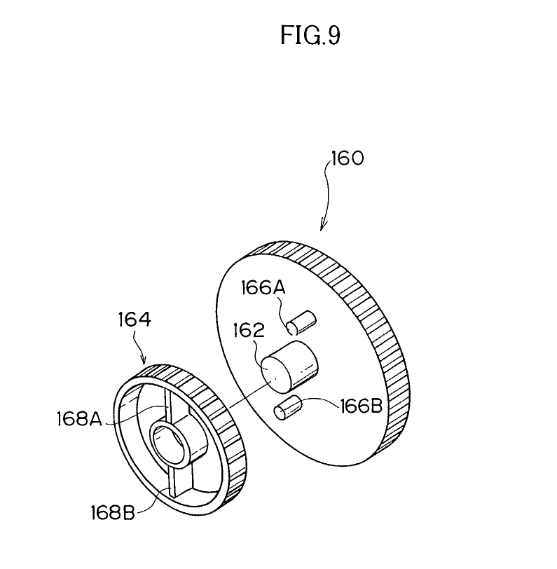

Note that, in the present embodiment, the mechanism for compensating velocity differential is disposed on an axis of the drive shaft 116. However, this mechanism can be disposed at any position through which a driving force from the drive source is transmitted to the drive shaft 116. For example, as shown in FIG. 8, a gear 158 for compensating velocity differential (referred to as a velocity differential compensating gear) also can be disposed between a drive gear 156 that is provided on an end of a drive shaft 154 of a motor (or drive source) 152 and a driven gear 150 that is provided on an end of the rotating shaft 116 of the drive roller 112A. As shown in FIGS. 8 and 9, the velocity differential compensating gear 158 is formed by a large diameter portion 160 and an idle gear 164. The large diameter portion 160 meshes with the drive gear 156 to transmit a rotational force. The idle gear 164 is rotatably mounted on a rotating shaft 162 of the large diameter portion 160 and transmits the rotational force to the driven roller 150. If there is no velocity differential, engaging protrusions 166A and 166B of the large diameter portion 160 abut and press against engaging portions 168A and 168B of the idle gear 164 so as to transmit the rotational force. In case of compensating for linear velocity differential, the engaging portions 168A and 168B move away from the engaging protrusions 166A and 166B.

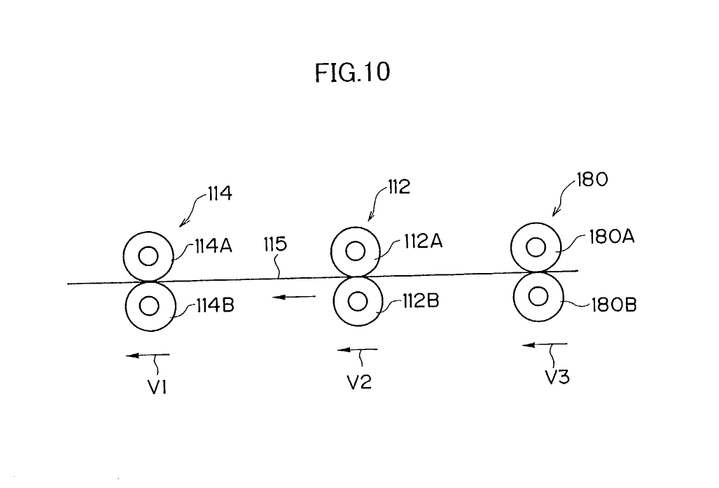

Further, in this embodiment, description has been given of the case in which two pairs of conveyance rollers are provided. However, the present invention is also applicable to any structure in which three or more pairs of conveyance rollers are provided such that said pairs of conveyance rollers can concurrently hold a same sheet. For example, the instant invention can be applied to a structure, as shown in FIG. 10, in which a further pair of conveyance rollers 180 is provided even further upstream than the conveyance roller pair 112 in the sheet conveyance direction if a relation V1>V2>V3 is satisfied, where V1, V2, and V3 are the conveyance speeds of the conveyance roller pairs 114, 112, and 180, respectively.

Furthermore, in this embodiment, description has been given of the structure in which the pairs of conveyance rollers are provided. The present invention is not limited to the same and can be applied to any conveyance structure in which a rotating shaft for transmitting a driving force is provided. For example, the invention is applicable to a structure in which a sheet is nipped and conveyed by a pair of opposed belts and to a structure in which a sheet is wound around a drum and conveyed.

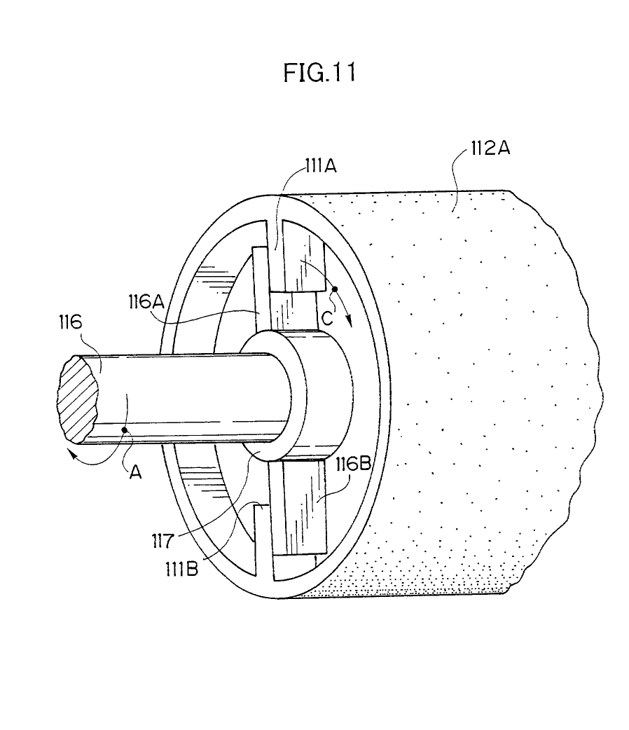

Moreover, as shown in FIG. 11, the mechanism for compensating velocity differential may be disposed between the drive shaft 116 and the drive roller 112A. Specifically, on the drive shaft is mounted an engaging member 117 which has a pair of engaging protrusions 116A and 116B that extend radially outward from the engaging member 117 and are formed at diametrically opposite positions with respect to the axis of the drive shaft 116. On the other hand, the drive roller 112A is substantially annular and includes an internal surface from which a pair of engaging prongs 111A and 111B project radially inward. The engaging prongs 111A and 111B are formed at diametrically opposite positions with respect to a rotational axis of the drive roller 112A (i.e., the axis of the drive shaft 116). In accordance with this structure as well, the same effects as those of the above-described first embodiment can be obtained.

Second Embodiment

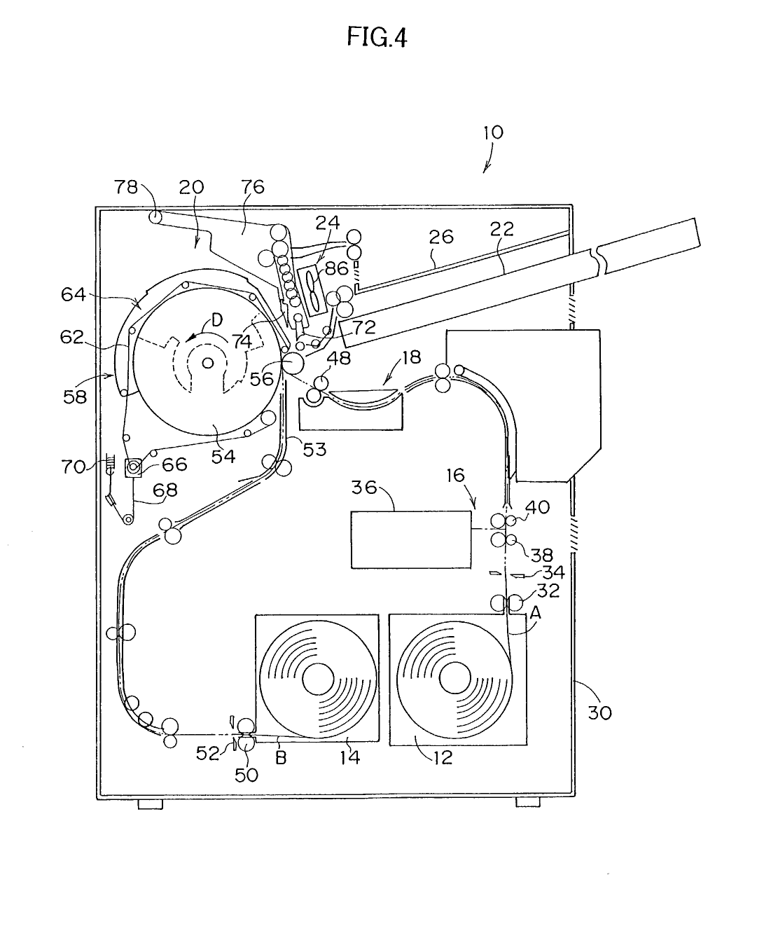

Referring now to FIGS. 4 to 6, an image forming apparatus 10 according to a second embodiment of the invention will be described. The image forming apparatus 10 utilizes substantially the same mechanism for compensating linear velocity differential as in the first embodiment. To eliminate descriptive redundancy with respect to the linear velocity differential compensating mechanism, overlapping description thereof will be accordingly omitted.

As shown in FIG. 4, the image forming apparatus 10 is basically formed by: a photosensitive material magazine 12, in which a photosensitive material A is stored; an image-receiving material magazine 14, in which an image-receiving material B is stored; an exposure section 16, in which an image is formed by exposing an image onto the photosensitive material A; a water-coating section 18, in which the photosensitive material A having the image formed thereon is coated with water; a heat development and image transfer section 20, in which the photosensitive material A, which has been coated with water, and the image-receiving material B are superposed and heated, so that a latent image that has been formed on the photosensitive material A is transferred to the image-receiving material B and developed; a storage tray 22 for receiving the photosensitive material A after it has been heat-developed and peeled away from the image-receiving material B; a drying section 24, in which the peeled image-receiving material B is dried; and a storage tray 26 for receiving the dried image-receiving material B dried.

An operation by which an image is formed will now be specifically described. Firstly, the photosensitive material A is pulled out from the photosensitive material magazine 12 by draw-out rollers 32. Thereafter, a sheet or piece of the photosensitive material A having a predetermined length is cut off therefrom by a cutter 34. In the exposure section 16, the photosensitive material A is scanned by a light beam from a light-scanning unit 36, whereby a latent image is formed on the photosensitive material A. The photosensitive material A is then applied with water in the water-coating section 18. Thereafter, a pair of squeeze rollers 48 removes excess water from the photosensitive material A and conveys the photosensitive material A to the heat development and image transfer section 20.

The image-receiving material B is pulled out from the image-receiving material magazine 14 by draw-out rollers 50, and a sheet or piece of the image-receiving material having a predefined length is cut off therefrom by a cutter 52. The image-receiving material B is then conveyed to the heat development and image transfer section 20.

The photosensitive material A and the image-receiving material B that have been conveyed to the heat development and image transfer section 20 are respectively fed in between a heat drum 54 and a nip roller or laminating roller 56 by the squeeze roller pair 48 and a guide member 53. The photosensitive material A and the image-receiving material B are laminated together while being pressed against the heat drum 54 with a relatively large pressure force for lamination by the laminating roller 56.

The photosensitive material A and the image-receiving material B thus laminated are moved in the direction of arrow D together with the rotation of the heat drum 54, and are held between an endless belt 62 of a belt support mechanism 58 and the heat drum 54. The endless belt 62 operates without relative slippage due to frictional resistance between the endless belt 62 and the heat drum 54. Therefore, relative displacement of the photosensitive material A and the image-receiving material B is prevented. Consequently, both materials are conveyed in the direction of arrow D synchronously with the rotational movement of the heat drum 54.

In this manner, the laminated photosensitive material A and the image-receiving material B are completely (i.e., from respective leading ends to respective trailing ends of the photosensitive material A and the image-receiving material B) wound around the heat drum 54 while being pressed by the belt support mechanism 58. At this time, rotation of the heat drum 54 is stopped, and the outer periphery of the heat drum 54 is heated to a predetermined temperature by a heater disposed within the heat drum 54. This operation, in which rotation of the heat drum 54 is stopped and the heat drum 54 is heated, is continued for a predetermined time until heat development and image transfer processing have been completed.

During this heat development and image transfer processing, the photosensitive material A releases a mobile colorant in reaction to the heat from the heat drum 54. This colorant is then transferred to a colorant-fixing layer of the image-receiving material B, whereby an image is obtained.

After the photosensitive material A and the image-receiving material B have been wound as far as their trailing ends around the heat drum 54, the laminating roller 56 is switched to press against the heat drum 54 with a relatively weak pressure force for separation by unillustrated operating means.

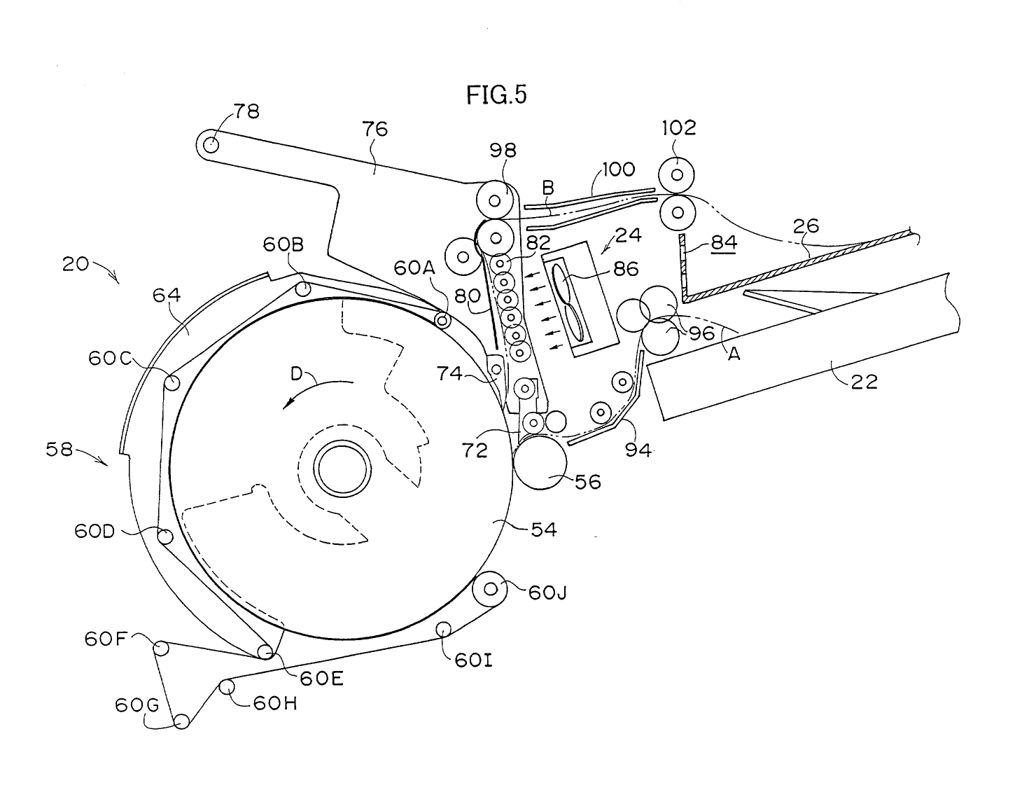

A mobile operating member 64 rotates and moves to a withdrawn position in synchrony with the change in pressure force of the laminating roller 56 (see FIGS. 4 and 5). As a result, a mounting member 76 supported by the mobile operating member 64 rotates such that a separation pawl 74 touches down on the peripheral surface of the heat drum 54. Additionally, a separation pawl 72, which has been in the position shown in FIG. 4, moves forward to a predetermined working position in the vicinity of the heat drum 54, as shown in FIG. 5.

Subsequently, the heat drum 54 is rotated so that the laminated photosensitive material A and the image-receiving material B are nipped again by the laminating roller 56. At this time, the laminating roller 56 is pressed against the heat drum 54 with a relatively weak pressure force for separation. Consequently, the photosensitive material A is peeled from the image-receiving material B and guided towards a guide member 94 by the separation pawl 72. The photosensitive material A is then received in the storage tray 22 from the guide member 94 and guide rollers 96.

Meanwhile, the image-receiving material B is further fed in the direction of arrow D from a position adjacent to the separation pawl 72 while sticking to the heat drum 54. Thereafter, the image-receiving material B is peeled from the outer periphery of the heat drum 54 by the separation pawl 74 and fed in between a guide member 80 and skewer- or comb-shaped rollers 82. While passing through the guide member 80 and the skewer-type rollers 82, the image-receiving material B is expeditiously dried by air blown thereto from a fan 86. Thereafter, the image-receiving material B is conveyed through guide rollers 98, guide members 100 and discharge rollers 102, and then received in the storage tray 26.

Description will now be given with respect to the exposure section 16 of the image forming apparatus, which incorporates a mechanism for compensating linear velocity differential.

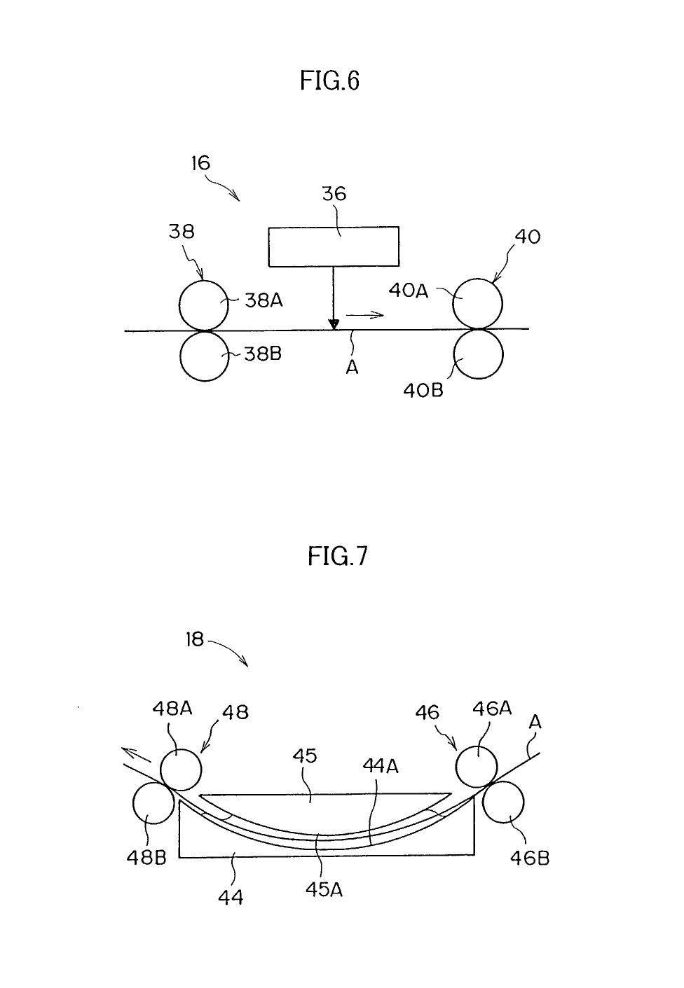

As shown in FIG. 6, the exposure section 16 includes a pair of conveyance rollers 38 that are disposed upstream in the conveyance direction and a pair of conveyance rollers 40 that are disposed downstream in the conveyance direction, with respect to a light-scanning position of the light-scanning unit 36. The conveyance roller pair 38 includes an upper drive roller 38A and a lower driven roller 38B, and the conveyance roller pair 40 includes an upper drive roller 40A and a lower driven roller 40B. This is a structure in which light-scanning is carried out when the photosensitive material A is nipped by both of the conveyance roller pairs 38 and 40.

Each of the drive rollers 38A and 40A is rotatingly driven in respective correspondence to the driven rollers 38B and 40B at a predefined speed by an individual drive source (not illustrated). Furthermore, a linear velocity differential compensating mechanism that is substantially the same as that of the first embodiment is disposed between the drive roller 38A and its corresponding drive source.

Operation of the above-structured exposure section 16 will now be described.

The rotational speed (i.e., linear speed) of the downstream conveyance roller pair 40 is higher than that of the upstream conveyance roller pair 38. By thus establishing an appropriate linear velocity differential between the conveyance roller pairs 38 and 40 supporting the photosensitive material A in a light-scanning position, the desired amount of tension in the photosensitive material A is induced such that a high degree of flatness may be ensured. Accordingly, it is possible to carry out high-quality image recording.

Moreover, a force responsive to the linear velocity differential is transmitted from the conveyance roller pair 40 to the conveyance roller pair 38 through the photosensitive material A. However, due to the operation of the mechanism for compensating linear velocity differential disposed between the conveyance roller pair 38 and its corresponding drive source, the conveyance roller pair 38 is rotated in compliance with the linear velocity differential so as to compensate for the linear velocity differential, thereby preventing the photosensitive material A from slipping on the conveyance roller pair 38. Accordingly, it is possible carry out image recording of an even higher image quality.

In this embodiment, description has been given of the exposure section 16 in the image forming apparatus 10, in which heat development and image transfer are carried out. However, the present invention is not limited to the same and is applicable to a write section in an inkjet printer, a developing section in a wet electrophotographic printer, and the like, where flatness of an image recording material is required.

Third Embodiment

Referring now to FIG. 7, an image forming apparatus according to a third embodiment of the present invention will be described. The image forming apparatus utilizes substantially the same mechanism for compensating linear velocity according to the first embodiment. Parts the same as those in the first and second embodiments are denoted by the same reference numerals and description thereof is omitted where appropriate. Description will be given of points of difference, and more specifically to the water-coating section 18 that incorporates the mechanism for compensating linear velocity differential.

As shown in FIG. 7, a conveyance path is defined between a bottom surface 44A of a water-coating bowl 44 and a bottom surface 45A of a guide member 45 in the water-coating section 18. The photosensitive material A is fed along the conveyance path by a sub-drive roller pair 46, with an emulsion layer of the photosensitive material A facing downward (towards the bottom surface 44A of the water-coating bowl 44), and is dipped in water supplied to the water-coating bowl 44. Excess water is subsequently removed from the photosensitive material A by the squeeze roller pair 48, which is a main drive roller pair, and then the photosensitive material A is conveyed to the heat drum 54.

If the photosensitive material A between the roller pairs 46 and 48 becomes slack due to a lack of tension applied thereto, the emulsion layer inevitably slides on the bottom surface 44A and sustains damage because the emulsion layer faces down, which results in poor image quality. As a countermeasure, the linear velocity (rotational speed) of the squeeze roller pair 48 is set to be higher than the linear velocity (rotational speed) of the sub-drive roller pair 46. Thus, a predetermined amount of tension is given to the photosensitive material A so that the photosensitive material A does not slide on the bottom surface 44A and damage is not caused to the emulsion layer.

If this tension becomes excessive, there is the potential for the photosensitive material A to be creased or to push up the bottom surface 45A and cause the guide member 45 to rise, due to the photosensitive material A slipping on the sub-drive roller pair 46 or strongly abutting against the bottom surface 45A of the guide member 45.

However, in the present embodiment, the mechanism for compensating linear velocity differential, which is substantially the same as that of the first embodiment, is disposed between the sub-drive roller pair 46 and its corresponding drive source in order to compensate any linear velocity differential possibly generated between the drive roller pairs 46 and 48. Thus, it is possible to prevent tension from becoming excessive such that the above-mentioned drawbacks (i.e., slippage of the photosensitive material A, creasing of the photosensitive material A and the like) can be eliminated. Accordingly, it is possible to form high-quality images.

In this embodiment, description has been given of the water-coating section 18 in the image forming apparatus, in which heat development and image transfer is carried out. However, the present invention is not limited to the same and is applicable to any structure in which development is conducted by immersing a recording material in a liquid bath.

As described above, in any of the mechanisms for compensating linear velocity differential according to the present invention, it is possible to reliably and efficiently compensate linear velocity differential with a simple structure. Further, an image forming apparatus incorporating such a mechanism for compensating linear velocity differential can perform satisfactory image forming.

What is claimed is:

1. A mechanism for compensating linear velocity differential, the mechanism being incorporated between a conveyance element that conveys a sheet and a transmitting element that is operatively connected to a drive source and comprising:
an engaging portion that is operatively connected to the conveyance element; and
an abutment portion that is operatively connected to the transmitting element and is detachable from and attachable to the engaging portion, wherein a driving force from the drive source is transmitted to the conveyance element by the abutment portion being pressed against the engaging portion.

2. The mechanism according to claim 1, wherein the conveyance element comprises a pair of rollers for grippingly conveying a sheet.

3. The mechanism according to claim 1, wherein the transmitting element is substantially annular and the engaging portion is received therein to be idly rotatable over a predetermined angular range.

4. The mechanism according to claim 1, wherein the transmitting element includes a drive gear.

5. The mechanism according to claim 1, wherein the engaging portion is formed on a rotatable shaft of the conveyance element and protrudes radially outward, and wherein the abutment portion is formed on a rotatable body of the transmitting element and protrudes radially inward.

6. The mechanism according to claim 1, wherein the engaging portion is formed on a rotatable body of the transmitting element and protrudes radially inward, and wherein the abutment portion is formed on a rotatable shaft of the conveyance element and protrudes radially outward.

7. The mechanism according to claim 1, wherein the engaging portion comprises at least one engaging prong and the abutment portion comprises at least one engaging protrusion.

8. A conveyance mechanism for conveying a sheet, the conveyance mechanism comprising:
(A) a first conveyance element;
(B) a second conveyance element that is disposed upstream of the first conveyance element relative to the conveyance direction, is able to grip the sheet simultaneously with the first conveyance element, and is rotatingly driven at a lower linear velocity than the first conveyance element; and
(C) a mechanism for compensating linear velocity differential including a transmitting element that is operatively connected to a drive source, the mechanism being incorporated between the transmitting element and the second conveyance element and including;
(i) an engaging portion operatively connected to the second conveyance element; and
(ii) a predetermined number of abutment portions operatively connected to the transmitting element and detachable from and attachable to the engaging portion, wherein a drive force from the drive source is transmitted to the second conveyance element by the abutment portions being pressed against the engaging portion.

9. The conveyance mechanism according to claim 8, further comprising a third conveyance element disposed upstream of the second conveyance element relative to the conveyance direction, and a mechanism for compensating linear velocity differential incorporated between the third conveyance element and the drive source.

10. The conveyance mechanism according to claim 8, wherein the second conveyance element comprises a conveyance roller for grippingly conveying the sheet, the abutment portions are arranged equidistantly about a periphery of the transmitting element and the speeds of the first conveyance element and the second conveyance element are controlled so as to satisfy the following relation:
πD/{n(V1−V2)}>Lmax/V2
wherein:
D is the diameter of the conveyance roller;
n is the number of the abutment portions;
V1 is the speed (i.e., linear velocity) at which the sheet is conveyed by the first conveyance element;
V2 is the speed (i.e., linear velocity) at which the sheet is conveyed by the second conveyance element; and
L max is a maximum length of the sheet in the conveyance direction.

11. The conveyance mechanism according to claim 8, wherein the second conveyance element comprises a conveyance roller for grippingly conveying the sheet, the abutment portions are arranged equidistantly about a periphery of the transmitting element and the second conveyance element is formed so as to satisfy the following relation:
πD/n<G
wherein:
D is the diameter of the conveyance roller;
n is the number of the abutment portions; and
G is the minimum interval between the sheets.

12. An image forming apparatus comprising:
(a) an image forming unit for forming an image on a recording material;
(b) a first conveyance roller pair for grippingly conveying the recording material, the first conveyance roller pair being disposed downstream of an image forming position relative to the conveyance direction;
(c) a second conveyance roller pair is disposed upstream in the conveyance direction from the image forming position, is able to grip the sheet simultaneously with the first conveyance roller pair, and is rotatingly driven at a lower linear velocity than the first conveyance roller pair; and
(d) a mechanism for compensating linear velocity differential which includes a transmitting element that is operatively connected to a drive source, the mechanism being incorporated between the transmitting element and one roller of the second conveyance roller pair.

13. The image forming apparatus according to claim 12, wherein the mechanism for compensating linear velocity differential comprises:
(i) an engaging portion operatively connected to said one roller of the second conveyance roller pair; and
(ii) an abutment portion operatively connected to the transmitting element and detachable from and attachable to the engaging portion, wherein a drive force from the drive source is transmitted to said one roller by the abutment portion being pressed against the engaging portion.

14. The image forming apparatus according to claim 12, wherein the image forming unit includes a light-scanning device.

15. The image forming apparatus according to claim 12, further comprising a liquid coating unit for coating the recording material with a liquid.

16. An image forming apparatus comprising:
(a) a liquid-processing unit for liquid-processing a recording material, on which an image has been formed, to form a predetermined image on the recording material;
(b) a primary drive roller pair for grippingly conveying the recording material, the primary drive roller pair being disposed downstream of a liquid-processing position relative to the conveyance direction;
(c) a secondary drive roller pair disposed upstream of the liquid-processing position relative to the conveyance direction, said secondary drive roller being able to grip the recording material simultaneously with the primary drive roller pair, and rotatingly driven at a lower linear velocity than the primary drive roller pair; and
(d) a mechanism for compensating linear velocity differential, which mechanism includes a transmitting element that is operatively connected to a drive source, the mechanism being incorporated between the transmitting element and one roller of the secondary drive roller pair.

17. The image forming apparatus according to claim 16, wherein the mechanism for compensating linear velocity differential comprises:
(i) an engaging portion operatively connected to said one roller of the secondary drive roller pair; and
(ii) an abutment portion operatively connected to the transmitting element and detachable from and attachable to the engaging portion, wherein a drive force from the drive source is transmitted to said one roller of the secondary drive roller pair by the abutment portion being pressed against the engaging portion.

18. The image forming apparatus according to claim 16, wherein the liquid-processing unit comprises a liquid-coating unit, which includes a liquid-coating bowl for storing the liquid therein and a guide member that is disposed above the liquid-coating bowl and has a guide surface for guiding the recording material into the liquid-coating bowl.

19. The image forming apparatus according to claim 18, wherein the liquid-coating bowl is concave and the guide surface is convex.

20. The image forming apparatus according to claim 16, further comprising an image forming unit for forming an image on the recording material.
